(19) United States
(12) Patent Application Publication
(10) Pub. No.: US 2024/0295711 A1
(43) Pub. Date: Sep. 5, 2024

(54) EQUIDISTANT FIBER LENGTH LATENCY MODULE

(71) Applicant: CommScope Technologies LLC, Hickory, NC (US)

(72) Inventors: Matthew J. HOLMBERG, Le Center, MN (US); Shawn Phillip TOBEY, Trinity, NC (US); David P. PERCIVAL, Tabernash, CO (US)

(21) Appl. No.: 18/591,653

(22) Filed: Feb. 29, 2024

Related U.S. Application Data
(60) Provisional application No. 63/449,537, filed on Mar. 2, 2023.

(51) Int. Cl. G02B 6/44; G02B 6/38

(52) U.S. Cl. CPC G02B 6/4457; G02B 6/3825; G02B 6/3879; G02B 6/4454

(57) ABSTRACT

A fiber optic latency module including at least two spools, each storing a known length of optical fiber with one end positioned on the inside and the other end positioned on the outside of the spool. A splice optically couples the two lengths of fiber, and a splice holder is provided to hold the splice. The splice holder can be positioned within the spool core of either spool. The first length of optical fiber is wound around the first spool in either a clockwise or counterclockwise direction, from the outside end to the inside end, while the second length of optical fiber is wound around the second spool in the opposite direction, from the inside end to the outside end. The module is designed to ensure consistent latency between different components of a fiber optic network or system by adding a predetermined amount of latency to fiber optic networks.

### CROSS-REFERENCE TO RELATED APPLICATION

This application claims the benefit of U.S. Provisional Application No. 63/449,537 (filed Mar. 2, 2023), titled “EQUIDISTANT FIBER LENGTH LATENCY MODULE,” the disclosure of which is hereby incorporated herein by reference.

### TECHNICAL FIELD

The present disclosure relates generally to fiber optic cables, and more particularly to a module that contains a predetermined length of optical fiber for modifying the latency between various components of an optical network.

### BACKGROUND

Fiber optic cables are made up of thin strands of glass or plastic that can transmit data and signals using light pulses instead of electrical signals. These cables have revolutionized the telecommunications industry by allowing for faster and more efficient communication over long distances.

Today, fiber optic technology is used in various applications, such as financial systems, medical equipment, military systems, and industrial automation. One of the advantages of fiber optic systems is their ability to transmit data over longer distances with less signal degradation than traditional copper cables. Additionally, fiber optic cables are less susceptible to electromagnetic interference, making them more reliable and secure.

To connect fiber optic systems in the field, one or more fiber optic cable assemblies are typically used. These systems typically include a length of fiber optic cable with fiber optic connectors mounted at opposing ends of the cable. In some cases, an adapter for mechanically and optically coupling one or more connectors together may also be provided. With the connectors aligned within the adapter, a fiber optic signal can pass from one cable to the next.

### SUMMARY

Some aspects of the disclosure are directed to a fiber optic latency module, which can be in the form of a self-contained panel or enclosure, which can be positioned in-line optical connection between two components to increase the latency of the optical signal between the two components. In some embodiments, the module can be in the form of a self-contained panel or enclosure, which allows it to be conveniently placed within an optical connection between two components. By doing so, this module can effectively increase the latency of the optical signal that travels between these two components.

One embodiment of the present disclosure provides an equidistant fiber length latency module in the form of a self-contained panel or enclosure that can be mounted in an equipment rack or cabinet. In one embodiment, the module can contain 864 single-mode fibers, each with a length of 4 kilometers, with a maximum tolerance for fiber strand length of 3″ (±1.5 inches or ±0.0381 meters), which is the equivalent of ±0.009525% (e.g., 0.0381 meters/4000 meters×100%) approximated as about ±0.01% of the total length of the fiber. The module can maintain Method A polarity and may use stranded fibers, ribbon fibers, or jacketed fibers. The module can utilize single-mode LC/UPC input and output connectors, with the option of shuttered duplex LC mating adapters. In some embodiments, the module can exhibit a QR Code label (placed in a location that can be seen/read after installation) that links performance and length data to WebTrak in a CSV downloadable file. Optical performance of the module can meet ULL performance requirements for Insertion Loss and Return Loss. Systems containing the module are expandable by adding additional modules as required.

Aspects of the present disclosure relate to a fiber optic latency module, including a first spool for storing a known first length of optical fiber, the first length of optical fiber extending between a first end and a second end, wherein the first end is positioned on the outside end of the first spool, and the second end is positioned on the inside end of the first spool, a second spool for storing a known second length of optical fiber, the second length of optical fiber extending between a third end and a fourth end, wherein the third end is positioned on the inside end of the second spool, and the fourth end is positioned on the outside end of the second spool, a splice optically coupling the second end of the first length of optical fiber to the third end of the second length of optical fiber, and a splice holder configured to hold the splice, wherein the splice holder is positionable within a spool core defined by at least one of the first spool or second spool, wherein the first length of optical fiber is wound around the first spool in one of a clockwise or counterclockwise direction, starting from the first end and ending with the second end, and the second length of optical fiber is wound in an opposite direction around the second spool, starting from the third end and ending with the fourth end.

In certain implementations, the fiber optic latency module further include a first housing defining one or more input ports, and a second housing defining one or more output ports. In certain implementations, the first housing is positioned coplanar with the first spool, and the second housing in position coplanar with the second spool, and wherein the first housing and the first spool are stacked relative to the second housing and the second spool.

In certain implementations, the first end of the first length of optical fiber terminates in one or more input connectors. In certain implementations, the one or more input connectors includes at least one of an MTP/MPO connector, a duplex LC connector, or an LC connector. In certain implementations, the fourth end of the second length of optical fiber terminates in one or more output connectors. In certain implementations, the one or more output connectors includes at least one of an MTP/MPO connector, a duplex LC connector, or an LC connector.

In certain implementations, a combined length of the first length of optical fiber and the second length of optical fiber has a defined fiber length of at least 50 meters with a tolerance of ±0.1% of the defined fiber length. In certain implementations, the defined fiber length measures 4 km with a tolerance of ±0.01% of the defined fiber length. In certain implementations, substantially one half of the defined fiber length is stored on the first spool and the remainder of the defined fiber length is stored on the second spool.

In certain implementations, the first length of optical fiber and the second length of optical fiber each comprise 24-fiber bare ribbon fiber optic cable. In certain implementations, the first housing defines 24-input ports configured to receive 24-input adapters, and the second housing defines 24-output ports configured to receive 24-output adapters. In certain implementations, the first housing and the first spool, and the second housing and the second spool, are at least partially housed within a housing configured to be received within a standard rack space. In certain implementations, the fiber optic latency module further includes a QR code label configured to guide users to latency data for the fiber optic latency module.

Another aspect of the present disclosure relates to a rack comprising a plurality of the fiber optic latency modules as described above. In certain implementations, the rack comprises at least two columns of thirty-six fiber optic latency modules.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic view depicting a fiber optic network including one or more fiber optic latency modules, in accordance with an embodiment of the disclosure.

FIG. 2 is a schematic view depicting a fiber-optic network including multiple branches with one or more fiber-optic latency modules, in accordance with an embodiment of the disclosure.

FIG. 3 depicts various components of a fiber-optic latency module, in accordance with an embodiment of the disclosure.

FIG. 4 is an exploded view depicting components of a fiber-optic latency module, in accordance with an embodiment of the disclosure.

FIG. 5 depicts how the components of the fiber-optic latency module of FIG. 4 are assembled, in accordance with an embodiment of the disclosure.

FIG. 6 depicts the assembled fiber-optic latency module of FIG. 5, in accordance with an embodiment of the disclosure.

FIG. 7 is a perspective view depicting a splice holder, in accordance with an embodiment of the disclosure.

FIG. 8 is a partial cross-sectional view, depicting the splice holder of FIG. 7, in accordance with an embodiment of the disclosure.

FIG. 9 is an exploded view depicting a fiber-optic latency module including three spools, in accordance with an embodiment of the disclosure.

FIG. 10 is a perspective view of a spool including a channel configured to enable passage of a fiber optic cable from an inside end to an outside end of the spool, in accordance with an embodiment of the disclosure.

FIG. 11 is a schematic view depicting optical fibers of a fiber-optic latency module, in accordance with an embodiment of the disclosure.

FIG. 12 is a perspective view of an MTP/MPO connector, in accordance with an embodiment of the disclosure.

FIG. 13 is a perspective view of a duplex LC connector, in accordance with an embodiment of the disclosure.

FIG. 14 is a perspective view of an LC connector, in accordance with an embodiment of the disclosure.

FIG. 15 is a perspective view of a rack including one or more columns of fiber-optic latency modules, in accordance with an embodiment of the disclosure.

FIG. 16 is a profile view of the rack of FIG. 15, in accordance with an embodiment of the disclosure.

FIG. 17 is a close-up, perspective view depicting a fiber-optic latency module positioned within a rack, in accordance with an embodiment of the disclosure.

FIG. 18 is a top view of a rack including one or more columns of fiber-optic latency modules, in accordance with an embodiment of the disclosure.

FIG. 19 is a perspective view depicting a rack including one or more columns of fiber-optic latency modules, in accordance with an embodiment of the disclosure.

FIG. 20 is a profile view of the rack of FIG. 13, in accordance with an embodiment of the disclosure.

FIG. 21 is a perspective view of a fiber-optic latency module housed in a panel housing, in accordance with an embodiment of the disclosure.

FIG. 22 is a partially exploded, perspective view of the fiber optic latency module of FIG. 21, in accordance with an embodiment of the disclosure.

FIG. 23 is a perspective view depicting a fiber-optic latency module of FIG. 21, in accordance with an embodiment of the disclosure.

FIG. 24 is a perspective view of a fiber-optic latency module positioned within a rack, in accordance with an embodiment of the disclosure.

FIG. 25 is a perspective view depicting a rack including a stack of fiber-optic latency nodules, in accordance with an embodiment of the disclosure.

### DETAILED DESCRIPTION

The length of a fiber optic cable can significantly impact the time it takes for a signal to be transmitted. As light travels through the cable, it experiences a slight delay caused by the physical properties of the fiber, including the refractive index and the length of the fiber. This delay, also known as latency, is directly proportional to the length of the fiber optic cable. In other words, the longer the cable, the greater the latency. This can be especially important for applications that require real-time data transmission, such as video conferencing, online gaming, and financial systems, among others.

For example, high-speed financial trading relies heavily on algorithms, which are computer programs that are designed to make quick and accurate trading decisions. These algorithms use complex mathematical models to analyze data and identify potential trading opportunities in real-time. In high-speed financial trading, even a small delay in the transmission of data can result in significant losses. Therefore, the time it takes for a signal to be transmitted between trading processors is critical, as the length of the fiber optic cable can have a direct impact on the transaction times as light travels through the cable at a finite speed.

Variations in length between processors can lead to situations where some customers with shorter cables have an advantage over others, as they can receive information and take action on that information faster than those with longer cables. This advantage can be significant, with some estimates suggesting that fractions of a second of latency can have a large impact in profit or loss for high-frequency traders. The use of such fiber optic cables in high-speed financial transactions represents one example where precision in fiber optic cable length is critical, and should not be considered limiting to the scope of this disclosure.

To establish consistency in the latency between various components of a fiber optic network, it is important to ensure that the fiber optic cables used to connect the various components have a similar latency (e.g., are of a similar length, etc.), regardless of the distance between the components. To address this problem, the present disclosure provides an equidistant fiber length latency module, which, in some embodiments can be in the form of a self-contained panel or enclosure that can be mounted in a standardized equipment rack or a freestanding cabinet. In some embodiments, each module in the equipment rack or cabinet can contain optical fibers having a total length in a range of between about 50 m and about 4 km, with a minimum tolerance of between about ±0.1% and about ±0.01% of the total length. In some embodiments, the module can employ a plurality of input and output connectors and adapters, including, but not limited to single-mode LC/UPC connectors and shuttered duplex LC mating adapters. Fiber optic networks or systems containing the module are expandable by adding additional modules to the equipment rack or cabinet as required.

Reference will now be made in detail to exemplary aspects of the present disclosure that are illustrated in the accompanying drawings. Wherever possible, the same reference numbers will be used throughout the drawings to refer to the same or like parts.

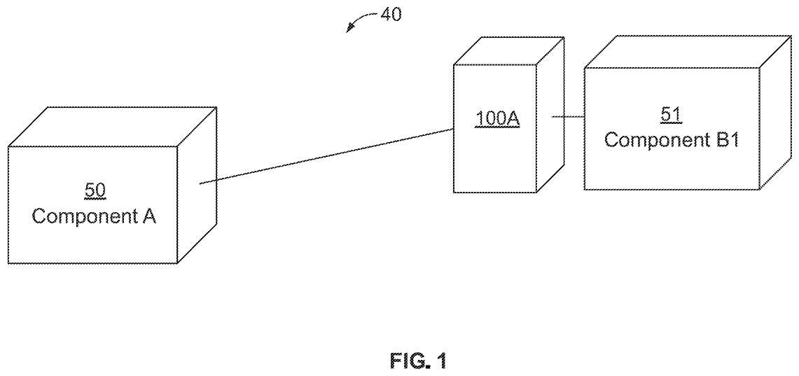

With reference to FIG. 1, a fiber optic network or system 40 comprising one or more fiber optic latency modules 100 is depicted in accordance with an embodiment of the disclosure. As depicted, the system 40 can include a first component 50 (referred to herein as “component A”), which can connect to one or more branch components 51 (referred to herein as component B1). User requirements may demand that the latency in optical signals traversing between the A-B1 components be increased by the equivalent of a certain distance. In the depicted example, the fiber-optic latency module 100 provides a compact solution that allows for the selective addition of latency between components of a fiber optic network or system to ensure a specific latency between components. For instance, one embodiment of the fiber-optic latency module 100 can maintain a consistent latency equivalent to a fiber optic cable many kilometers long between branches of the network, regardless of how close the components are physically positioned relative to one another. Moreover, the fiber-optic latency module 100 provides the increase in latency without the bulk and storage requirements associated with traditional fiber-optic cabling.

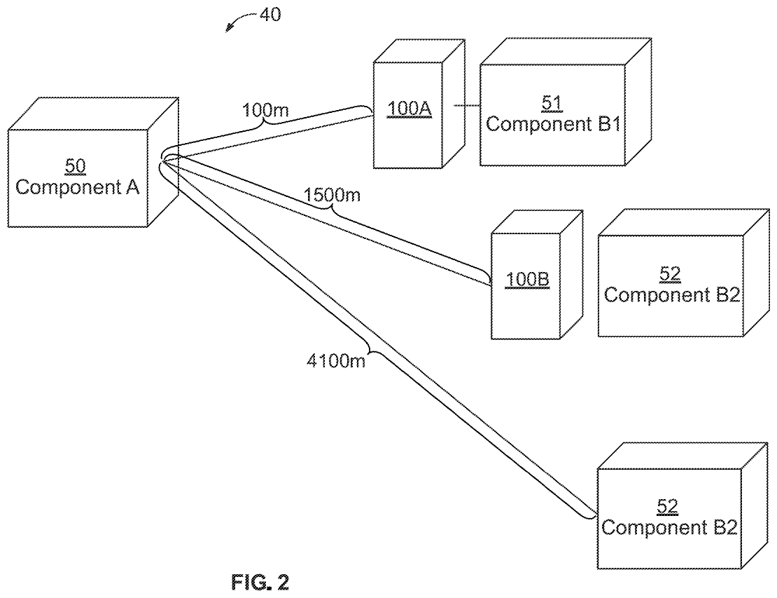

With additional reference to FIG. 2, another example fiber-optic network or system 40 comprising one or more fiber optic latency modules 100 is depicted in accordance with an embodiment of the disclosure. As depicted, the system 40 can include a first component 50, and a plurality of branch components 51, 52 and 53 (referred to herein as components B1, B2 and B3, respectively). User requirements may demand that the latency in optical signals traversing between the A-B1, A-B2 and A-B3 components be substantially equal; however, as can be seen in the schematic, each of the branch components 51, 52 and 53 may be positioned at different physical locations from one another, such that different lengths of optical fiber cables may be required to connect the branch components 51, 52 and 53 to the first component 50. For example, the first component 51 may be positioned adjacent to first component 50 (e.g., requiring a 100 m cable), the second component 52 may be positioned approximately 1500 m away from the first component 50, and the third component 53 may be positioned 4.1 km away from the first component 50. Traditional ruggedized fiber-optic cabling may connect the various components 50, 51, 52, and 53.

To ensure that the latency between the first component 50 and the branch components 51, 52 and 53 are substantially equal, one or more fiber optic latency modules 100 may be utilized to increase the latency in certain branches. In this particular example, the longest path is between A-B3. Accordingly, the system 40 must introduce latency to the optical signals traversing between A-B1 and A-B2 to match the latency of the optical signal traversing between A-B3. For example, the fiber-optic latency module 100A may introduce 4 km of latency between A-B1 to match that of A-B3. Similarly, fiber-optic latency module 100B may introduce 2600 m of latency between A-B2 to match that of A-B3. In some embodiments, multiple fiber-optic latency modules 100 can be connected in series to achieve a desired combined latency. Moreover, the fiber-optic latency module 100 is configured to fit within a relatively compact space.

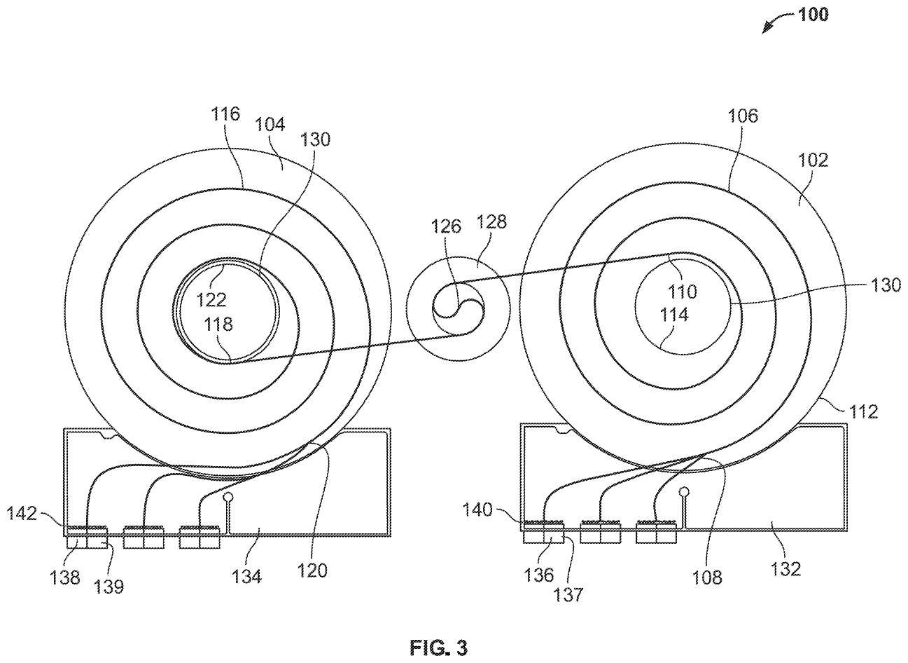

With additional reference to FIG. 3, a fiber optic latency module 100 is depicted in accordance with an embodiment of the disclosure. As depicted, the fiber optic latency module 100 can include a first spool 102 and a second spool 104. Each of the first and second spools 102, 104 can be generally in the shape of a cylindrical device configured to store fiber optic cables. For example, in some embodiments, each of the spools 102, 104 can generally be in the form of a circular drum or reel, constructed of a rigid material such as plastic or metal.

In embodiments, a first length of optical fiber 106 can be wound around the first spool 102. The first length of optical fiber 106 can extend between a first end 108 (occasionally referred to as the input end) and a second end 110. In embodiments, the first length of optical fiber 106 can be wound in either of a clockwise or counterclockwise rotation around the spool 102, such that the first end 108 is positioned on the outside end 112 of the first spool 102, and the second end 110 is positioned on the inside end 114 of the first spool 102. In embodiments, the outside end 112 of the spool refers to the portion or edge of the spool 102 closest to the outer perimeter, while the inside end 114 of the spool refers to the portion or edge of the spool 102 closest to the central hub.

In embodiments, a second length of optical fiber 116 can be wound around the second spool 104. The second length of optical fiber 116 can extend between a third end 118 and a fourth end 120 (occasionally referred to as the output end). In some embodiments, the second length of optical fiber 116 can include a fiber pigtail cable and splice, such that the second length of optical fiber 116 is of the correct length to form (collectively with the first length of optical fiber 106) the required latency of the fiber-optic latency module 100. In embodiments, the second length of optical fiber 116 can be wound in a direction opposite to that of the first length of optical fiber 106, such that the third end 118 is positioned on the inside end 122 of the second spool 104, and the fourth end is positioned on the outside end 124 of the second spool 104. Again, in embodiments, the outside end 124 refers to the portion or edge of the spool 104 closest to the outer perimeter, while the inside end 122 refers to the portion or edge of the spool 104 closest to the central hub.

Although the first spool 102 and the second spool 104 are schematically depicted as circular, other shapes and configurations (e.g., ovals, geometric shapes and patterns, etc.) are also contemplated. Moreover, embodiments of the spools 102, 104 may include cable retention features configured to aid in retention of portions of the first and second lengths of optical fiber 106, 116. Moreover, although the respective ends of the first and second lengths of optical fibers 106, 116 are described generally as being positioned in proximity to either of the inside end or outside end of the spools 102, 104, each of the respective ends 108, 110, 118, 120 may include lengths of fiber that extend away from the spool 102, 104 thereby enabling splicing and/or connection to one or more connectors. Thus, the respective ends 108, 110, 118, 120 of the various cables do not necessarily represent the terminal end face of the optical fibers, but rather portions of the optical fiber in proximity to the end faces of the optical fibers.

In embodiments, each of the first and second lengths of optical fiber 106, 116 can include one or more individual fibers comprised of a glass core and a glass cladding surrounded by a polymer coating. In some embodiments, the polymer coating can be a multilayer coating, including at least one coating layer configured to act as a shock absorber to minimize attenuation caused by any micro-bending of the coated optical fiber. An optional second coating layer may be configured to protect the inner primary coating layer against mechanical damage, and to act as a barrier to lateral forces. The outer diameter of the coated optical fiber 100 may be about 200 μm, about 250 μm, or any other suitable value. Optionally, an ink layer may be arranged over the coating layer to color the fiber (e.g., as is commonly used in ribbonized fibers), or a coloring agent may be mixed with the coating material that forms coating layer.

In some embodiments, the first and second lengths of optical fiber 106, 116 can be in the form of multi-fiber ribbons. For example, in one embodiment, the optical fibers 106, 116 can each include twelve optical fibers and a matrix encapsulating the optical fibers. The optical fibers can be substantially aligned with one another in a generally parallel configuration, preferably with an angular deviation of no more than one degree from true parallel at any position. Although twelve optical fibers is described in the ribbon, it is to be appreciated that any suitable number of multiple fibers (but preferably at least four fibers) may be employed to form optical fiber ribbons suitable for a particular use. In some embodiments, the optical fibers 106, 116 can include bundles of multi-fiber ribbons. Ribbon cable provides the advantage of being easily spliced or terminated using special tools, which enable rapid installation and connection to other optical components. The use of ribbon also makes it easier to bundle and route large numbers of fibers, which can save space in crowded installations. In some embodiments, the multi-fiber ribbons can be rollable, or other technique improving the flexibility of the optical fibers.

In some embodiments, the module 100 can include a splice 126 positioned between the first length of optical fiber 106 and the second length of optical fiber 116. In embodiments, the splice 126 can be one of a number of different types of optical splices. For example, in some embodiments, the splice 126 can be a fusion type splice which involves melting the ends of the two fibers together to form a permanent bond. In some embodiments, the fibers are aligned using a fusion splicer machine, which applies heat to the ends of the fibers until they melt and fuse together. Other types of splices, including a mechanical splice, ribbon splice, bare fiber splice, pigtail splice, and mid-span splice are also contemplated.

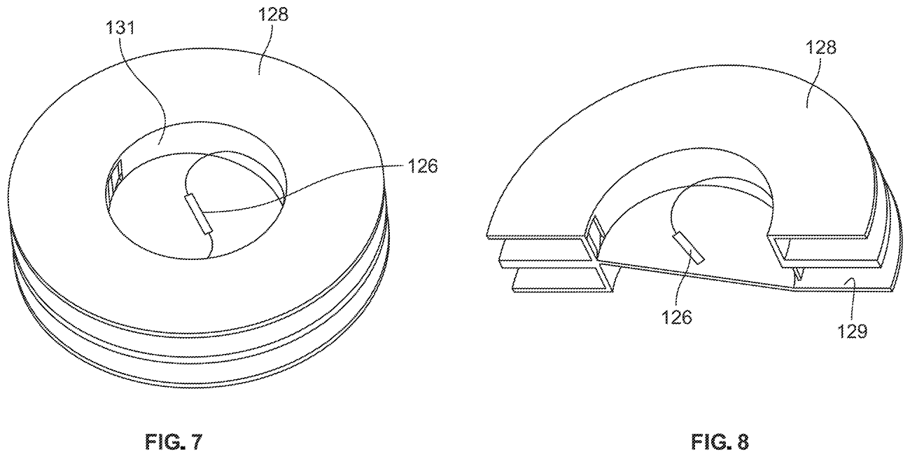

In some embodiments, the fiber optic latency module 100 can include a splice holder 128 configured to hold the splice 126. As depicted, the splice holder 128 can be positioned within a spool core 130 defined by either of the first or second spools 102, 104. For example, in some embodiments, each of the spools 102, 104 can define a hollow spool core 130, and the splice holder 128 can be shaped and sized to be stored or otherwise housed within the spool core 130. Although the splice holder 128 is depicted as being round, other shapes and profiles of the splice holder 128 are also contemplated. As best depicted in FIGS. 7-8, in some embodiments, the splice holder 128 can be configured as a spool defining one or more channels 129 configured to retain excess optical cable between the first and second lengths of optical fiber 106, 116. In some embodiments, rotation of the splice holder 128 about an axis passing through its central hub 131 can serve to wind excess portions of optical cable around the splice holder 128 for storage in the one or more channels 129.

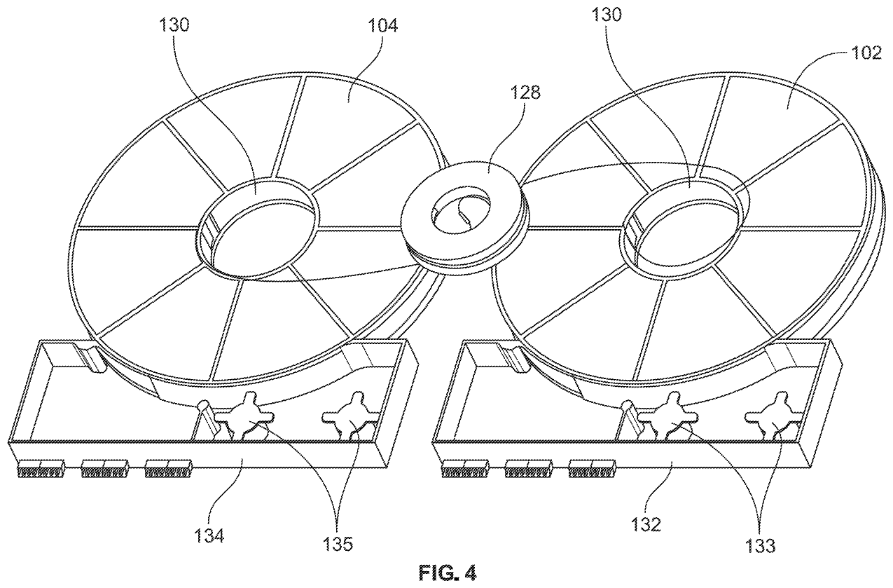

With continued reference to FIGS. 3-4, the fiber optic latency module 100 can include a first housing 132, and a second housing 134, each of which can define a plurality of ports. For example, the first housing 132 can define one or more input ports 136, and the second housing 134 can define one or more output ports 138. In some embodiments, each of the input ports 136 and output ports 138 can be configured to receive an adapter 137, 139, into which a connectorized end of the first length of optical fiber 106 or second length of optical fiber 116 can be optically connected. As depicted, in some embodiments, the first housing 132 can define 24-input ports configured to receive 24-input adapters 137, and the second housing 134 can define 24-output ports configured to receive 24-output adapters 139; although other quantities of ports and adapters are also contemplated. Connector iced cables connect at adapters 137 from Component A. Connector is cables connected adapters 139 from respective branch Components B1, B2, etc.

In some embodiments, the first housing 132 can be positioned coplanar with the first spool 102, and the second housing 134 can be positioned coplanar with the second spool 104. Specifically, the first housing 132 and second housing 134 can generally extend away from the first or second spool 102, 104 in a radial direction in the same plane as the spool of fiber wrapped around the respective first or second spool 102, 104. As best depicted in FIG. 4, and some embodiments, each of the first housing 132 and second housing 134 can include one or more cable retention features 133, 135, which can aid in storing excess fiber optic cable traversing between the outer ends of the respective spools 102, 104 and the ports 136, 138.

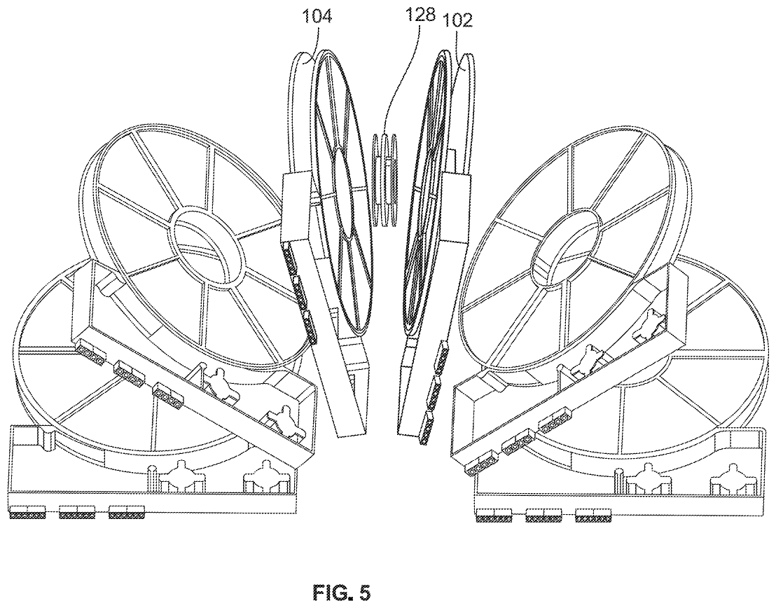

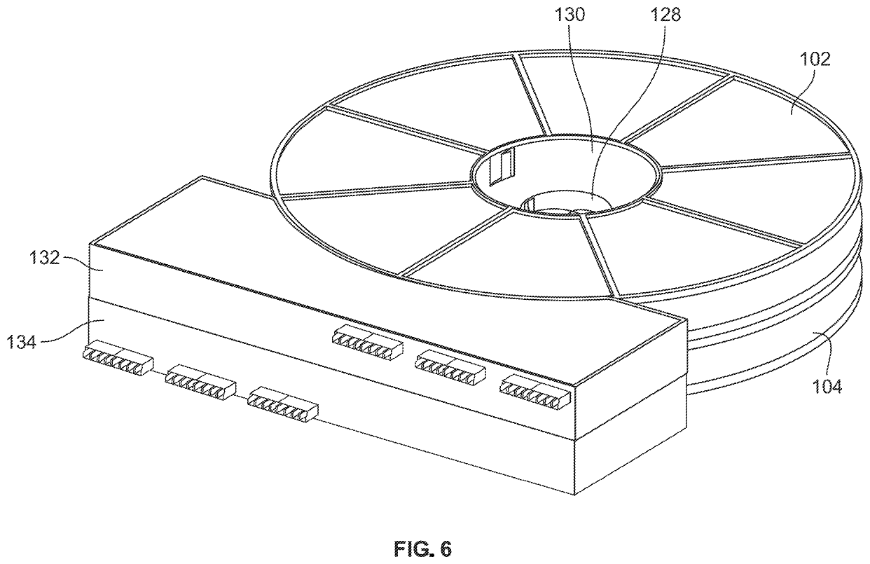

As further depicted in FIGS. 5-6, for a reduced footprint of the fiber optic latency module 100, in some embodiments, the first housing 132 and first spool 102 can be stacked or arranged vertically relative to the second housing 134 and second spool 104. Specifically, the first housing 132 and first spool 102 can be positioned above or below the second housing 134 and second spool 104 along an axis extending through a center of the first or second spool 102, 104, which can be positioned substantially orthogonal to the plane of spooled of fiber wrapped around the respective first or second spool 102, 104.

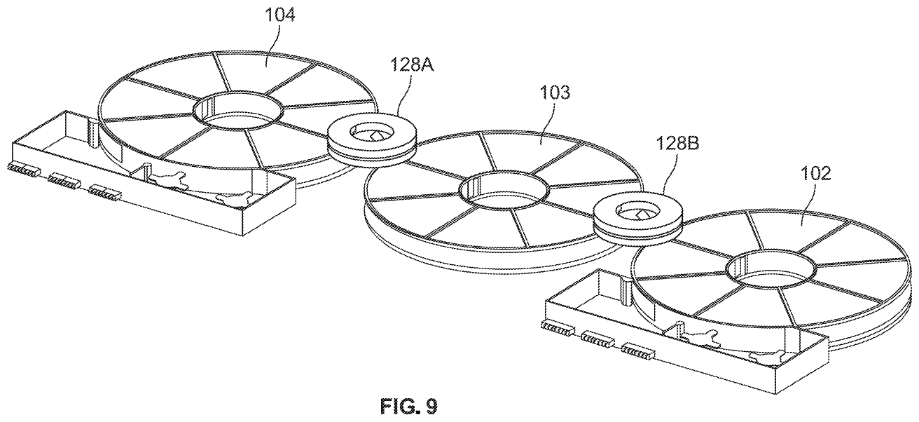

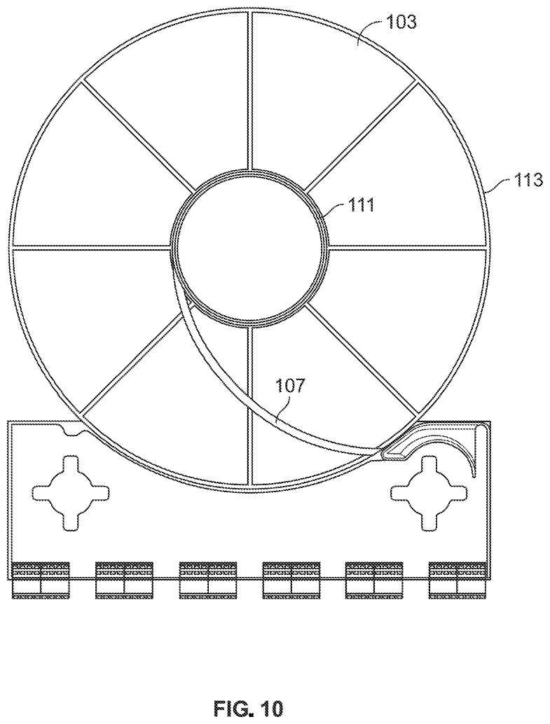

Although the fiber-optic latency module 100 is depicted as including a pair of spools 102, 104, and other embodiments, a greater or fewer number of spools may be used. For example, with additional reference to FIG. 9, in some embodiments, the total length of fiber optic cable can be stored on three spools, including first spool 102, second spool 104, and an intermediate spool 103 positioned between the first spool 102 and the second spool 104. To enable the splices between the various spools 102, 103, 104 to be positioned within a central hub of the spools, in some embodiments, at least one of the spools can be of the type shown in FIG. 10, in which a channel 107 is defined by the spool 103 to enable fiber-optic cable positioned on the inside end 111 of the spool to be routed to an outside end 113 of the spool. In yet other embodiments, the entire length of fiber-optic cable contained within the fiber optic latency module 100 can be contained on a single spool 103.

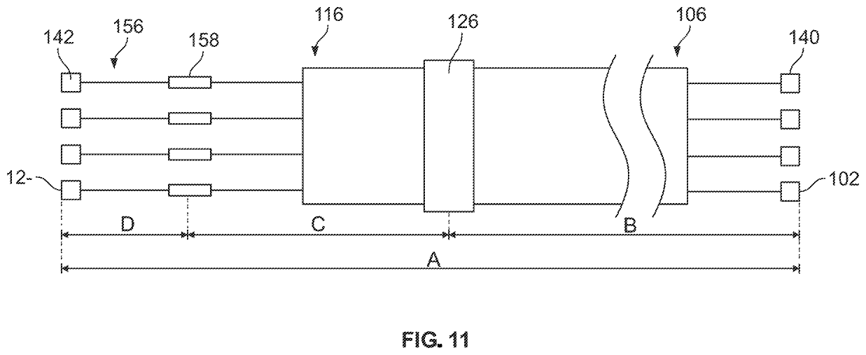

As best depicted in FIG. 11, in some embodiments, a combined length of the optical fibers within the fiber optic latency module 100 can be a defined cable length (A). The optical fibers can be assembled by coupling the first length of optical fiber 106 having a length (B) with the second length of optical fiber 116 having a length (C), for example via splice 126. To ensure that the combined length of the optical fibers meets the defined cable length (A requirements), in some embodiments, one or more fiber pigtail cables 156 having a length (D) can be spliced onto either of the first or second length of optical fiber 106, 116, for example via splice 158, thereby creating a combined length of the optical fibers having a total length (A). In such an embodiment, a connectorized end of the fiber pigtail cable 156 can represent either first end 108 or fourth end 120, such that the fiber pigtail cable 156 becomes part of either of the first length of optical fiber 106 or second length of optical fiber 116.

In some embodiments, a length of the optical fiber and be determined through a time-of-flight process, in which an observed travel time for an optical signal traversing between respective ends of the cable is multiplied by velocity of the optical signal to determine a precise length of the cable. For example, an observed travel time for an optical signal traversing between the first end 102 of the first length of optical fiber 106 and the fourth end 120 of the second length of optical fiber 116 can be multiplied by the velocity of the optical signal to determine a precise length of the combined first and second lengths of optical fiber 106, 116.

In embodiments, the fiber pigtail cable 156 can have a second known length. With knowledge of the precise length of the combined first and second lengths of optical fiber 106, 116 determined through a time-of-flight process, either of the first length of optical fiber 106, second length of optical fiber 116, or the fiber pigtail cable 156 trimmed, and the fourth end 120 of the second length of optical fiber 116 can be spliced to the fiber pigtail cable 156, wherein the resulting combined length of the optical fiber components 106, 116, 156 equals the total length (A) within an acceptable tolerance.

In some embodiments, the acceptable tolerance can be represented as a percentage of the total length (A). For example, a 50 meter cable with the maximum tolerance of 3 inches (±1.5 inches or ±0.0381 meters) is equivalent to about ±0.0762% (e.g., 0.0381 meters/50 meters×100%). In another example, a 4000 meter (e.g., 4 km) cable with the maximum tolerance of ±0.0381 meters is equivalent to about ±0.0009525% (e.g., 0.0381 meters/4000 meters×100%). Other tolerance limits are also contemplated. For example, in some embodiments, the acceptable tolerance can be represented in terms of a maximum length that can be added or subtracted to the total length (A) while still meeting and customer latency demands. In other embodiments, the acceptable tolerance can range from less than about 0.1% to less than about 0.001%. Other tolerance limits that satisfy user latency requirements are also contemplated.

For example, in one embodiment, the total length can measure about 50 m within a tolerance of about 0.1% of the total length. In one embodiment, the total length can measure about 100 m within a tolerance of about 0.038% of the total length. In one embodiment, the total length can measure about 150 m within a tolerance of about 0.025% of the total length. In one embodiment, the total length can measure about 400 m within a tolerance of about 0.01% of the total length. In one embodiment, the total length can measure about 500 m within a tolerance of about 0.008% of the total length. In one embodiment, the total length can measure about 1000 m within a tolerance of about 0.004% of the total length. In one embodiment, the total length can measure about 1500 m within a tolerance of about 0.003% of the total length. In one embodiment, the total length can measure about 2000 m within a tolerance of about 0.0019% of the total length. In one embodiment, the total length can measure about 2500 m within a tolerance of about 0.0015% of the total length. In one embodiment, the total length can measure about 3000 m within a tolerance of about 0.0013% of the total length. In one embodiment, the total length can measure about 4000 m within a tolerance of about 0.001% of the total length.

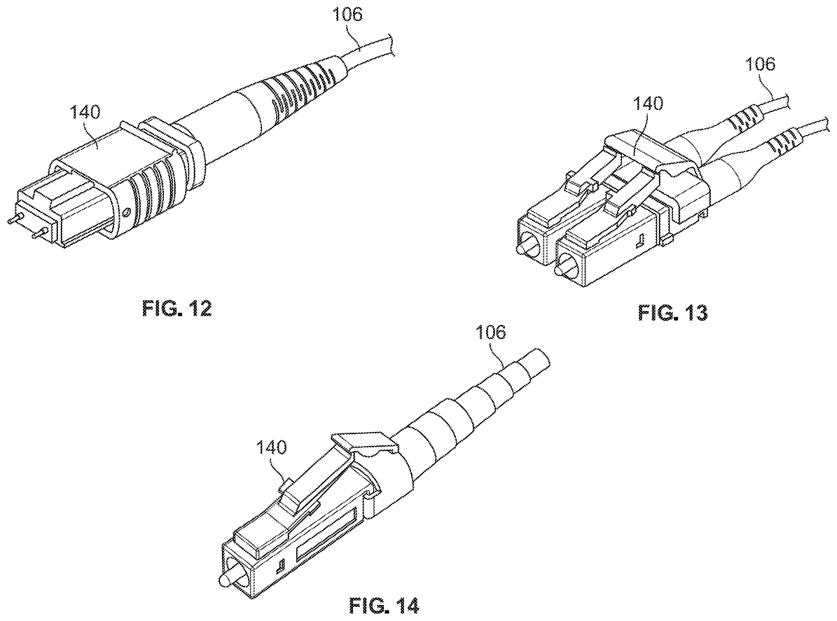

In some embodiments, the first end 108 of the first length of optical fiber 106 can terminate in one or more connectors 140. Additionally, in some embodiments, the fourth end 120 of the second length of optical fiber 116 can terminate in one or more connectors 142. For example, in one embodiment, either of the first end 108 or fourth end 120 can include at least one MTP/MPO connector (as depicted in FIG. 12), a duplex LC connector (as depicted in FIG. 13), or an LC connector (as depicted in FIG. 14) or other types of connectors (e.g., SC connectors, etc.). In some embodiments, the connectors 140, 142 can be ferrule-less connectors. In embodiments, various combinations of different connectors can be used together on fiber optic latency module 100. For example, depending upon the needs of the user, in some embodiments, the first end 102 may be outfitted with MPO connectors, while the fourth end 120 may be outfitted with LC connectors, etc.

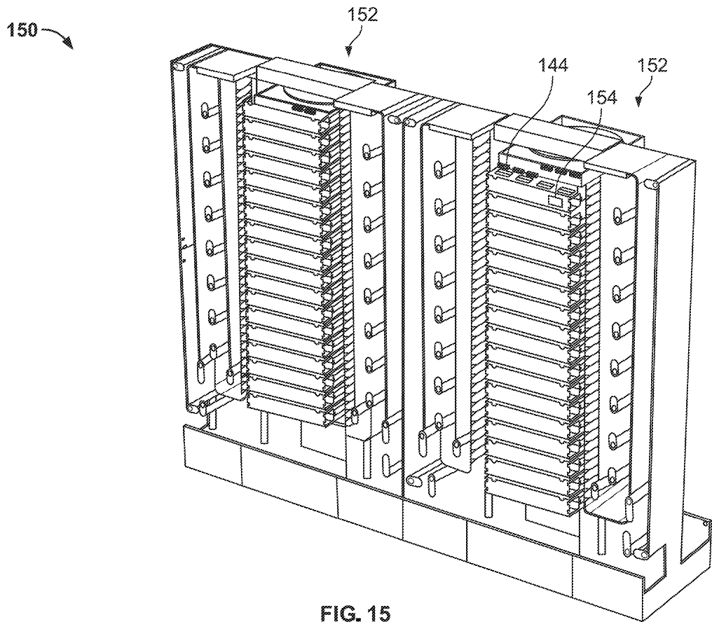

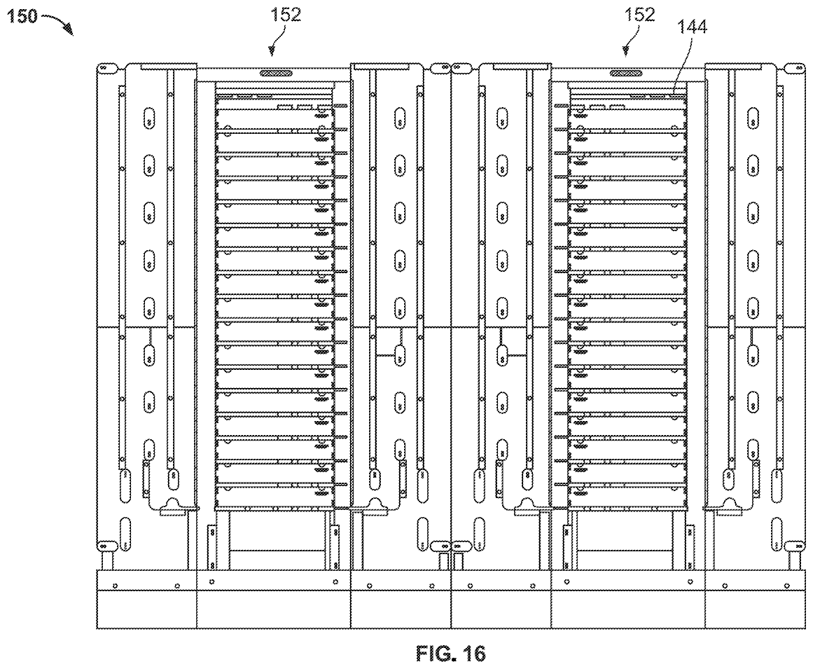

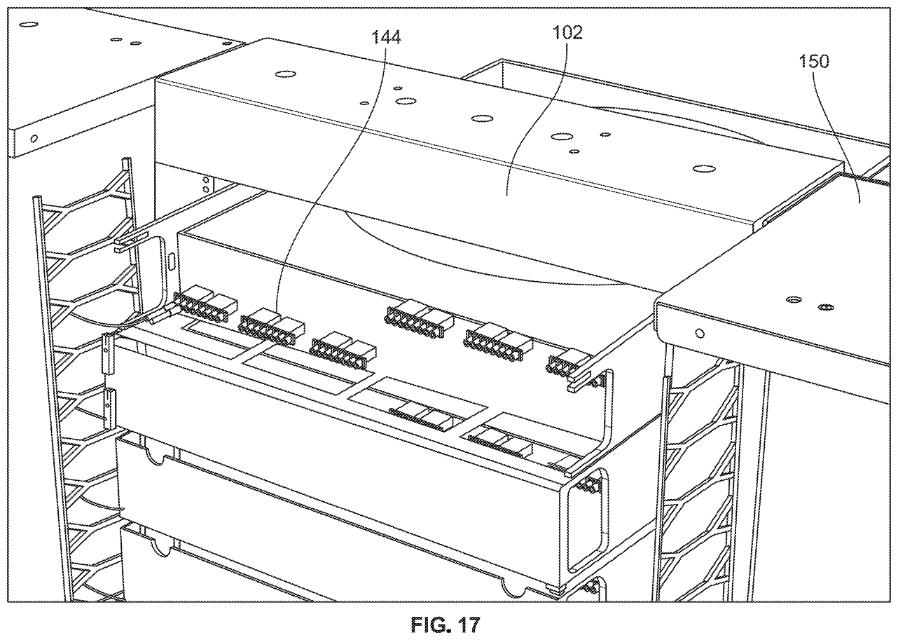

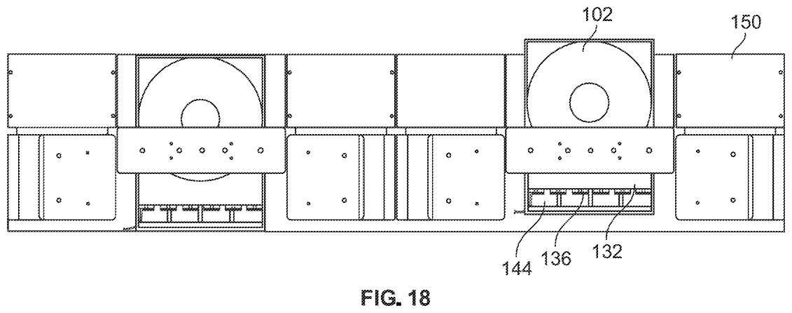

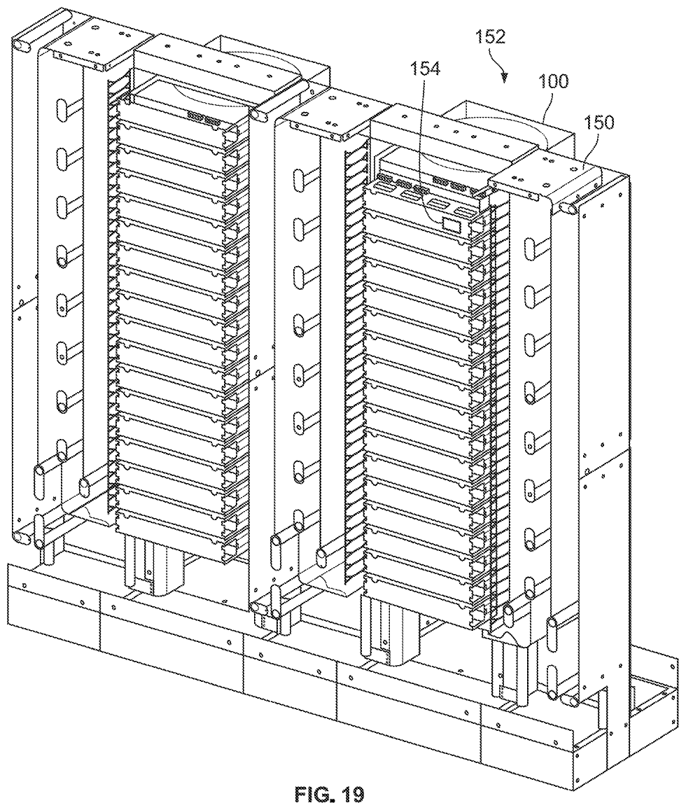

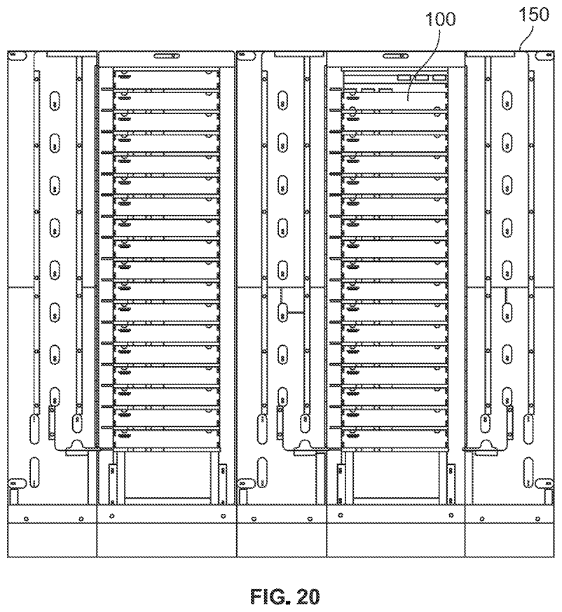

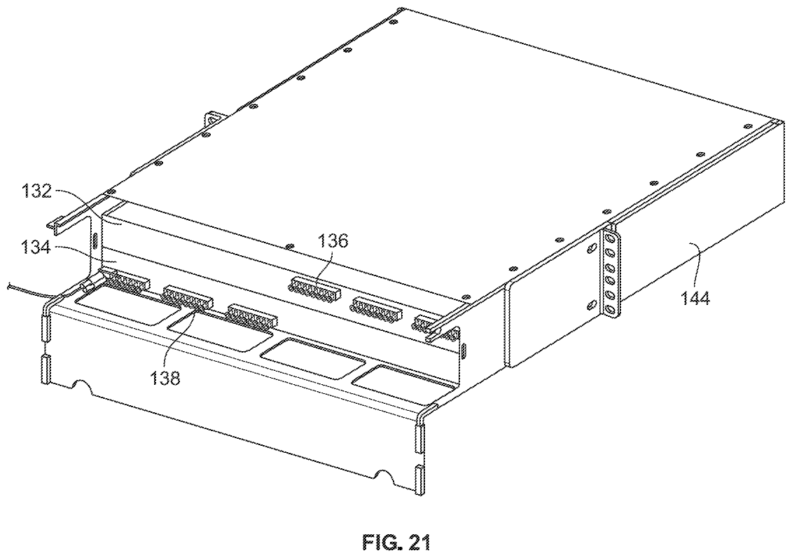

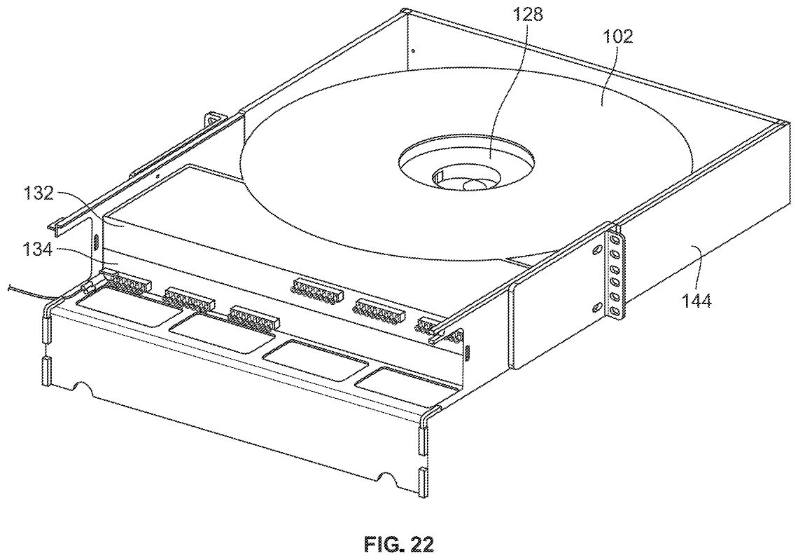

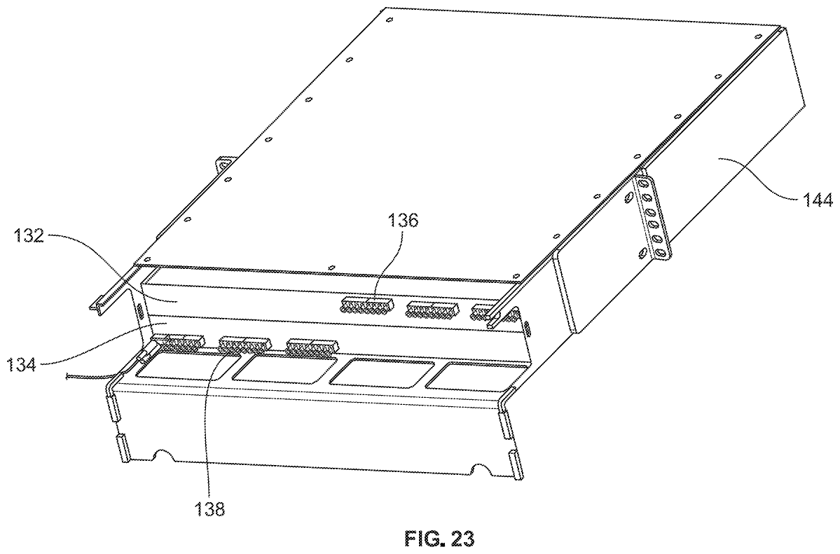

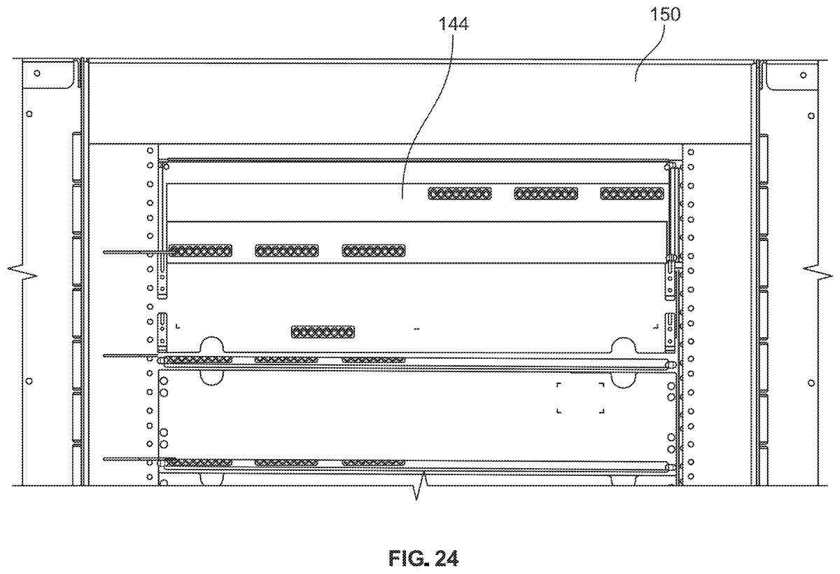

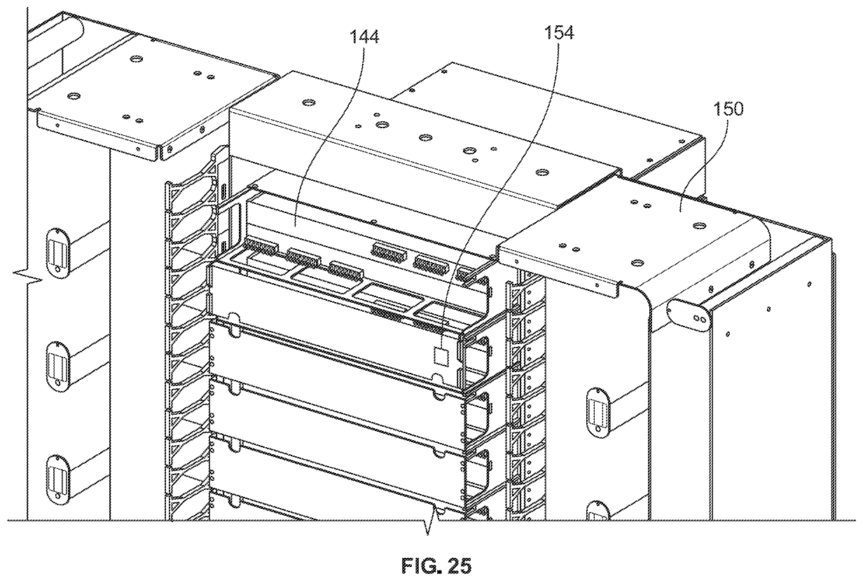

As further depicted in FIGS. 15-25, the first housing 136 and first spool 102, and the second housing 134 and second spool 104 can be configured to be at least partially received within a panel housing 144 configured to be received within a standard equipment rack. For example, in some embodiments, a rack 150 can be constructed to include a plurality of stacks of fiber optic latency modules 100. For example, as depicted, in some embodiments, the rack 150 can include two or more columns 152, each containing a stack of fiber optic latency modules 100. For ease in identifying latency properties of each fiber optic latency module 100, and some embodiments, a QR code label 154 can be affixed to a front portion of the panel housing 144 to guide users to latency data for the fiber optic latency module 100.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A fiber optic latency module, comprising:
a first spool for storing a known first length of optical fiber, the first length of optical fiber extending between a first end and a second end, wherein the first end is positioned on the outside end of the first spool, and the second end is positioned on the inside end of the first spool;
a second spool for storing a known second length of optical fiber, the second length of optical fiber extending between a third end and a fourth end, wherein the third end is positioned on the inside end of the second spool, and the fourth end is positioned on the outside end of the second spool;
a splice optically coupling the second end of the first length of optical fiber to the third end of the second length of optical fiber; and
a splice holder configured to hold the splice, wherein the splice holder is positionable within a spool core defined by at least one of the first spool or second spool, wherein the first length of optical fiber is wound around the first spool in one of a clockwise or counterclockwise direction, starting from the first end and ending with the second end, and the second length of optical fiber is wound in an opposite direction around the second spool, starting from the third end and ending with the fourth end.

2. The fiber optic latency module of claim 1, further comprising a first housing defining one or more input ports, and a second housing defining one or more output ports.

3. The fiber optic latency module of claim 2, wherein the first housing is positioned coplanar with the first spool, and the second housing in position coplanar with the second spool, and wherein the first housing and the first spool are stacked relative to the second housing and the second spool.

4. The fiber optic latency module of claim 1, wherein the first end of the first length of optical fiber terminates in one or more input connectors.

5. The fiber optic latency module of claim 4, wherein the one or more input connectors includes at least one of an MTP/MPO connector, a duplex LC connector, or an LC connector.

6. The fiber optic latency module of claim 1, wherein the fourth end of the second length of optical fiber terminates in one or more output connectors.

7. The fiber optic latency module of claim 6, wherein the one or more output connectors includes at least one of an MTP/MPO connector, a duplex LC connector, or an LC connector.

8. The fiber optic latency module of claim 1, wherein a combined length of the first length of optical fiber and the second length of optical fiber has a defined length of between about 50 meters and about 4000 meters with a tolerance of ±1.5 inches.

9. The fiber optic latency module of claim 1, wherein a combined length of the first length of optical fiber and the second length of optical fiber has a defined length of at least 50 meters with a tolerance of about ±0.0381 meters.

10. The fiber optic latency module of claim 1, wherein a combined length of the first length of optical fiber and the second length of optical fiber has a defined length of between about 50 meters and about 4000 meters with a tolerance of between about ±0.0762% and about ±0.009525% of the combined length.

11. The fiber optic latency module of claim 1, wherein a combined length of the first length of optical fiber and the second length of optical fiber has a defined length of between about 50 meters and about 4000 meters with a tolerance of at least ±0.01% of the combined length.

12. The fiber optic latency module of claim 11, wherein substantially one half of the combined length is stored on the first spool and the remainder of the defined length is stored on the second spool.

13. The fiber optic latency module of claim 1, wherein the first length of optical fiber and the second length of optical fiber each comprise 24-fiber bare ribbon fiber optic cable.

14. The fiber optic latency module of claim 2, wherein the first housing defines 24-input ports configured to receive 24-input adapters, and the second housing defines 24 output ports configured to receive 24-output adapters.

15. The fiber optic latency module of claim 2, wherein the first housing and the first spool, and the second housing and the second spool, are at least partially housed within a housing configured to be received within a standard rack space.

16. The fiber optic latency module of claim 1, further comprising a QR code label configured to guide users to latency data for the fiber optic latency module.

17. A rack comprising a plurality of the fiber optic latency modules of claim 1.

18. The rack of claim 13, wherein the rack comprises at least two columns of thirty-six fiber optic latency modules.
